(19) United States
(12) Patent Application Publication
(10) Pub. No.: US 2013/0052315 A1
(43) Pub. Date: Feb. 28, 2013

(54) Methods and Compositions for Protecting Beverages From Heat and Light Stress

(71) Applicants: Rashmi Tiwari, White Plains, NY (US); Thananunt Rojanasasithara, Yonkers, NY (US); Glenn Michael Roy, Beacon, NY (US)

(72) Inventors: Rashmi Tiwari, White Plains, NY (US); Thananunt Rojanasasithara, Yonkers, NY (US); Glenn Michael Roy, Beacon, NY (US)

(73) Assignee: PepsiCo, INC., Purchase, NY (US)

(21) Appl. No.: 13/216,324

(22) Filed: Aug. 24, 2011

(51) Int. Cl. A23L 2/58

(52) U.S. Cl. 426/269; 426/590; 426/540; 426/599

(57) ABSTRACT

Beverage products containing a color derived from a natural source or its synthetic equivalent further include a compound selected from a hydroxymethane sulfonic acid (HMSA) and ergothioneine to inhibit fading of the color derived from a natural source or its synthetic equivalent. Methods of making the beverages with reduced color-change are further provided.

### FIELD OF THE INVENTION

This invention relates to beverages and other beverage products that include juices and/or colors derived from natural sources, such as finished beverages, concentrates, syrups and the like. In particular, this invention relates to beverage products having formulations for preventing or reducing color change.

### BACKGROUND

It has long been known to produce beverages of various formulations. Problems with beverage formulations remain, however. Following manufacture, beverage products are generally not refrigerated during distribution and may be subjected excessive heat during transport and also during storage prior to sale. These environmental exposures can affect beverage color. Similarly, exposure to light may have a bleaching effect leading to color fading.

In addition to fading, beverages can develop visual brown color, a phenomenon known as “browning,” which is a ubiquitous problem in the food and beverage industry. Two types of browning occur: enzymatic browning and non-enzymatic browning. Both can be promoted by various factors, including time, elevated storage temperature, and air permeability of packaging material (carton, drum or glass).

Inhibition and control of non-enzymatic browning depends on product composition, storage, time, and temperature (Lozano 2006; Roig et al., 1999). Non-enzymatic browning is driven by the Maillard reaction. The Maillard reaction produces desirable brown colors in baked goods, frying or roasting. However, in beverage applications, brown color is undesirable. In addition to color change, nutritional loss occurs when essential amino acids and/or vitamin C is degraded.

The Maillard reaction is a complex series of chemical interactions initiated by a reaction between an amino acid and a reducing sugar, usually requiring the addition of heat, which results in the formation of brown polymeric melanoidins (Ziderman et al., 1989). The sugar reacts with amino acids, producing a variety of odors, flavors, and finally brown color. (Ibarz et al., 2008).

Many chemicals contribute to browning colors and flavors. For example, furfural and hydroxymethylfurfural (HMF) are characteristic compounds of the Maillard reaction. Non-enzymatic browning also plays a role in acid-catalyzed thermal decomposition of reducing sugars into reactive intermediates (Lee and Nagy, 1988). Formation of HMF, 2,5-dimethyl-4-hydroxy-3(2H)-furanone (DMHF), and furfural result from degradation of sugars and by degradation of ascorbic acid (Lee and Nagy 1996). Melanins and other chemicals also contribute to the brown color.

Because HMF is a recognized indicator of non-enzymatic browning, it is often used as an index of deteriorative changes that take place during excessive heating. The HMF content provides a measure of the degree of heating of the treated products during processing and is thus considered a quality parameter for concentrated food products.

In fruit juice concentrates, high temperature manufacturing processes, such as juice concentration, fruit dehydration, or storage at improper temperature, are thought to promote HMF formation. According to Garza et al. (1999) a significant increase in HMF content during thermal treatment of peach puree occurred at several high temperatures including 85, 90, and 98° C.

Oxygen and heat are believed to be the principle drivers of ascorbic acid degradation during juice processing, packaging, and storage. Oxidation reactions are accelerated at higher temperatures thereby resulting in product degradation (Clegg 1964). From a chemical degradation perspective, ascorbic acid is converted to dehydroascorbic acid (DHAA) in a reversible aerobic pathway (Sawarnura, 2000). DHAA has the same activity as Vitamin C. The subsequent irreversible conversion of DHAA to 2,3-diketogulonic acid (DKGA) by oxidation causes a loss in Vitamin C activity. DKGA can be further converted to furfural in aerobic and anaerobic pathways. The formation of furfural through an aerobic pathway predominates over the anaerobic degradation of ascorbic acid, being at one-tenth or up to one-thousandth of the rate of ascorbic acid loss under aerobic conditions (Kefford, et. al. 1958). Furfural formation is dependent on temperature, time, pH, concentration of juice and ascorbic acid content (Kus, et. al. 2005).

Various approaches to reducing browning have been explored. Chemicals such as chelating agents, complexing agents, and enzyme inhibitors have been found to reduce both enzymatic and non-enzymatic browning in fruits and fruit juices. Chemical anti-browning agents have been commonly used to prevent browning of fruits and fruit products. Anti-browning agents are compounds that act primarily on the enzyme, react with the substrates and/or products of enzymatic catalysis, or inactivate precursors of non-enzymatic pathways in a manner that inhibits colored product formation.

Adding SO₂, Sn²+ (tin) or cysteine to concentrated lemon juice affects color during storage. Beverages containing 125 ppm SO₂ showed inhibited browning when stored at 45° C. At higher levels (250 ppm), the degradation of ascorbic acid and the formation of furfural and HMF were inhibited. In addition adding Sn²+ (1000 mg/kg juice) reduced browning to about one-third the rate obtained in the absence of tin. Other methods of inhibiting non-enzymatic browning include adding L-cysteine and N-acetyl-L-cysteine (Naim and others 1993). However, juices with added N-acetyl-L-cysteine suffer from inferior aroma.

Sulfites reduce o-quinone produced by PPO catalysis to the less reactive diphenol, preventing development of brown melanins (Lozano 2006). Sulfite use is less desirable, however, due to its tendency to induce severe allergic reactions in susceptible individuals (Sapers 1993), and the FDA restricts sulfite use in certain fruit and vegetable products for that reason. When added, sulfites may be used as sulfur dioxide, sulfurous acid, sodium or potassium sulfite, bisulfite, or metabisulfite in non-enzymatic browning applications as well. Maximum levels of 300, 500 and 2000 ppm have been proposed for fruit juices, dehydrated potatoes, and dried fruit, respectively (Taylor et. al. 1986).

Consumers have a wide range of choices ranging from 100% juices to juice drinks containing lesser amounts of juice. Beverage producers need to provide quality products in attractive packaging in order to insure a successful product in the marketplace (Ucherek 2000). Thus, it is extremely important that manufacturers manage the quality of product they are putting on the shelves to maintain customer retention. Thermo-processing, packaging, storage, presence of components can all be key drivers of product desirability. Loss of quality is exhibited by flavor/aroma degradation, loss of vitamins and color, microbial growth, and browning. Quality loss in juices can often be due to browning, accompanied by development of off-flavors (Culver 2008) as well as the undesirable color. Any of these contributing factors of quality loss can reduce consumer acceptance (Koca et al., 2003).

Accordingly, it is an object of the invention to provide beverages and other beverage products having desirable appearance, taste and health properties by reducing undesirable color change. It is an object of at least certain embodiments of the invention to provide beverages and other beverage products having improved formulations to inhibit fading of colors derived from natural sources and having improved formulations that inhibit non-enzymatic browning. These and other objects, features and advantages of the invention or of certain embodiments of the invention will be apparent to those skilled in the art from the following disclosure and description of exemplary embodiments.

### SUMMARY

In one aspect of the disclosure, a beverage product is provided. The beverage product includes water, a color derived from a natural source or its synthetic equivalent, and a compound to inhibit fading of the color derived from a natural source or its synthetic equivalent. The compound is a hydroxymethane sulfonic acid or ergothioneine.

In another aspect of the disclosure, a beverage product is provided that contains juice and a hydroxymethane sulfonic acid at an amount effective to inhibit non-enzymatic browning.

In yet another aspect of the disclosure, a method of inhibiting color change in a beverage product is provided. Color change is inhibited by adding an effective amount of a hydroxymethane sulfonic acid to the beverage.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIGS. 1A and 1B illustrate the effects of compounds on gardenia blue color stability in response to light.

FIG. 2 illustrates the effects of compounds on gardenia blue color stability in response to heat.

FIG. 3 illustrates the effect of PHMSA and ergothioneine on heat-induced fading of sweet potato and black carrot color.

FIG. 4 illustrates the effect of PHMSA and ergothioneine on light-induced fading of colors derived from natural sources.

FIG. 5 illustrates the effect of chemicals including ergothioneine and sodium metabisulfite on heat-induced browning in lemon juice.

FIG. 6 illustrates inhibition of heat-induced browning in juice by PHMSA and by tin chloride.

FIG. 7 illustrates the effect of compounds on heat-induced browning in orange juice.

FIG. 8 illustrates the sustained efficacy of PHMSA in reducing heat-induced browning in juice.

### DETAILED DESCRIPTION

In an aspect of the disclosure, methods of reducing color changes in response to heat stress in beverages are provided. In another aspect of the disclosure, methods of reducing color changes in response to light stress in beverages are provided.

Color changes in beverages can occur through non-enzymatic browning but also through other mechanisms; for example, colors derived from natural sources can be used to color beverage products but they can fade in response to heat and/or light exposure.

It was discovered that stabilized alpha-hydroxymethane sulfonic acids (HMSAs) are effective for reducing heat- and light-induced browning in beverages. Advantageously, the HMSAs also reduce heat- and light-induced fading of color derived from one or more natural sources. HMSAs can therefore be used to promote color stability in beverages that suffer from non-enzymatic browning and/or color fading in response to light or heat.

Various HMSAs may be used to promote color stability. Exemplary suitable HMSAs acids are listed in Table 1.

TABLE 1

| Compound | CAS Number |
|---|---|
| pyridyl hydroxymethane sulfonic acid | 3343-41-7 |
| quinoline-hydroxymethane sulfonic acid | 864431-27-6 |
| pyrimidine hydroxymethane sulfonic acid | 802561-57-5 |
| Tetrahydropyrimidine hydroxymethane | 779312-67-3 |
| sulfonic acid | |
| imidazole hydroxymethane sulfonic acid | 771413-49-1 |
| quinoxaline hydroxymethane sulfonic acid | 501428-64-4 |
| riboflavin hydroxymethane sulfonic acid | 93775-68-9 |
| pteridine hydroxymethane sulfonic acid | 93775-67-8 |

Stabilized alpha-hydroxymethane sulfonic acids are shown by the generic Formula I below:

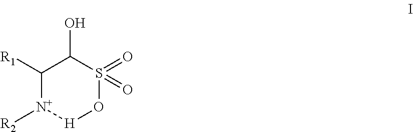

wherein R₁ and R₂ form, together with the nitrogen, a pyridine, a quinoline, a pyrimidine, a tetrahydropyrimidine, an imidazole, a quinoxaline, a riboflavin, or a pteridine.

2-pyridyl hydroxymethane sulfonic acid (PHMSA) is particularly suitable for inhibiting color-change as shown by Formula II:

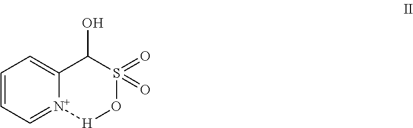

HMSAs inhibit fading of colors derived from natural sources. Colors derived from natural sources may be added to beverages to enhance their appeal to consumers. However, these colors can fade in response to heat and/or in response to light. One or more HMSAs may be added to a beverage to inhibit fading of natural colors in response to hear and/or light. In some embodiments, a HMSA may be PHMSA. In other embodiments, a HMSA may be riboflavin hydroxymethane sulfonic acid. More than one HMSA may be added to a beverage. Each HMSA is added in an effective amount to inhibit to obtain the desired effect. For example, the amount of HMSA may be in a range of: about 50 ppm to 500 ppm, about 50 ppm to 250 ppm, or about 50 ppm to 100 ppm. “About,” as used herein means plus or minus 10% of the indicated amount.

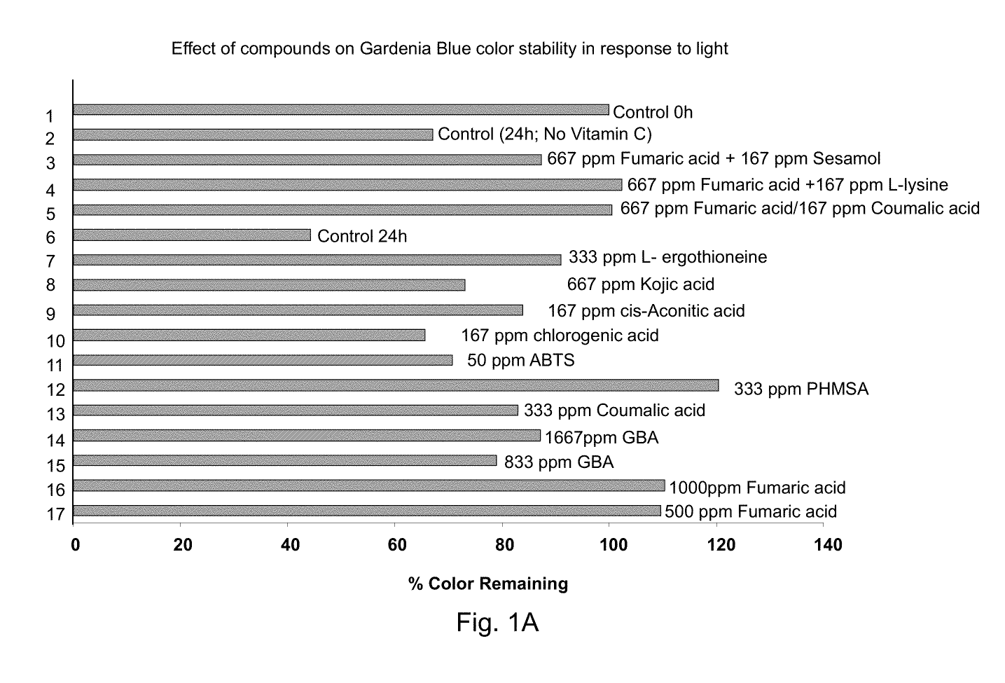

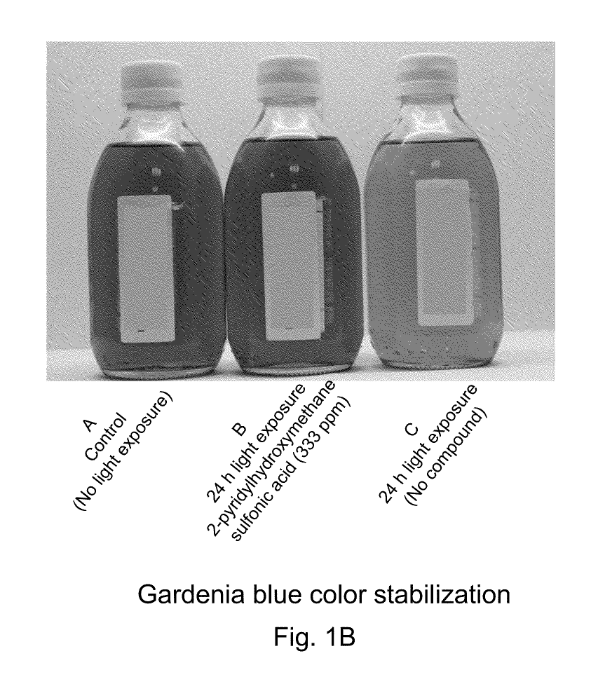

PHMSA reduces light-induced fading of colors derived from natural sources. See Example 1. In response to light, gardenia blue color faded approximately 50% over a 24 hour period (FIG. 1A, Row 1 vs Row 6). Of several compounds added to beverage compositions to test color-protecting effects, PHMSA was the most effective (FIG. 1A, Row 12). FIG. 1B illustrates these results visually. After 24 hours exposure to light, the gardenia blue faded substantially (FIG. 1B; Bottle C). Bottle A was stored in the dark to prevent light-induced fading and showed little or no fading. Notably, however, when PHMSA was added to a beverage composition exposed to light very little light-induced fading, if any, occurred (FIG. 1B; Bottle B).

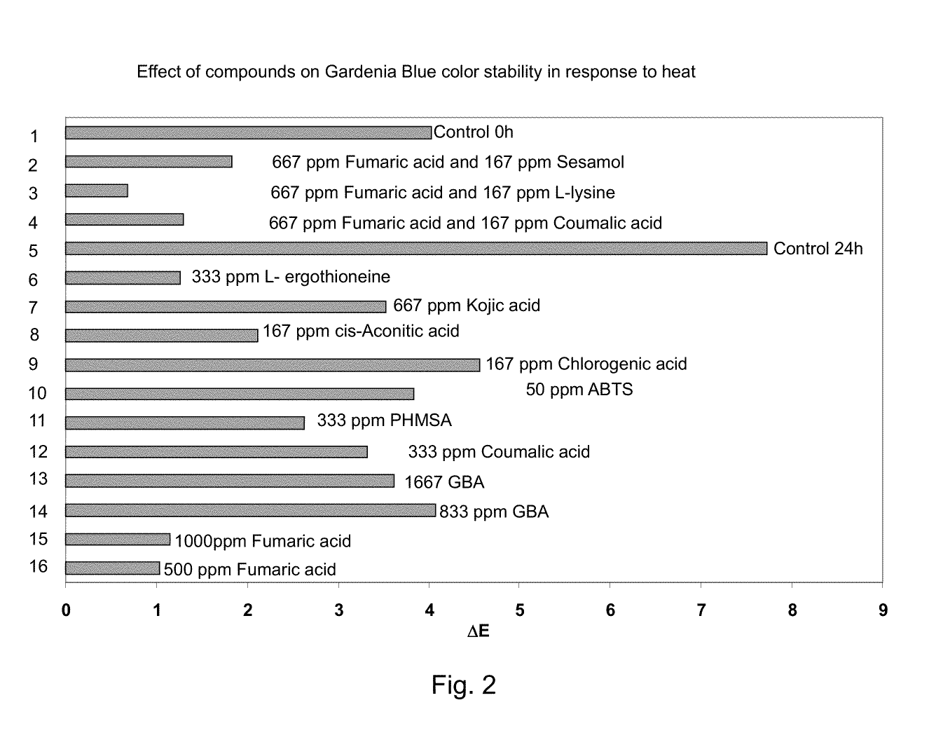

HMSAs also inhibit heat-induced fading of natural colors. FIG. 2 shows the ΔE values for a gardenia blue beverage. ΔE values provide a measure of total color difference between two samples. ΔE is calculated from the L, a, and b values, which indicate lightness, red/green levels, and yellow/blue levels, respectively, and are determined using a Colorimeter, such as a Hunterlab Colorimeter. ΔE is calculated according to the formula:

ΔE=(ΔL²+Δa²+Δb²)^{1/2}

Higher ΔE values indicate a greater degree of color change in a treated beverage relative to a control beverage. The beverages were heated for a week at 110° F. in the presence or absence of the indicated compounds. The ΔE value of 7 for the heat-treated control indicated that the heat treatment induced substantial loss of the gardenia blue color. Including PHMSA in the beverage reduced heat-induced fading to a ΔE value of 4, illustrating the protective effect of HMSAs.

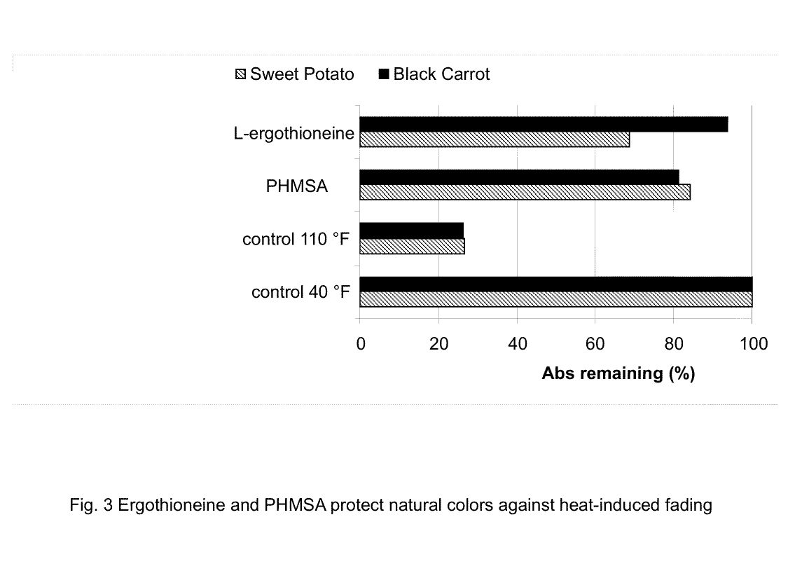

HMSAs protect against heat-induced color-change in other colors derived from natural sources. See FIG. 3. Sweet potato (FIG. 3; hatched line row) and black carrot (FIG. 3; solid row) colors exposed to 110° F. retained less than 30% of their original color. When PHMSA was added to the beverages, however, at least 75% of each color, measured by absorbance, was retained.

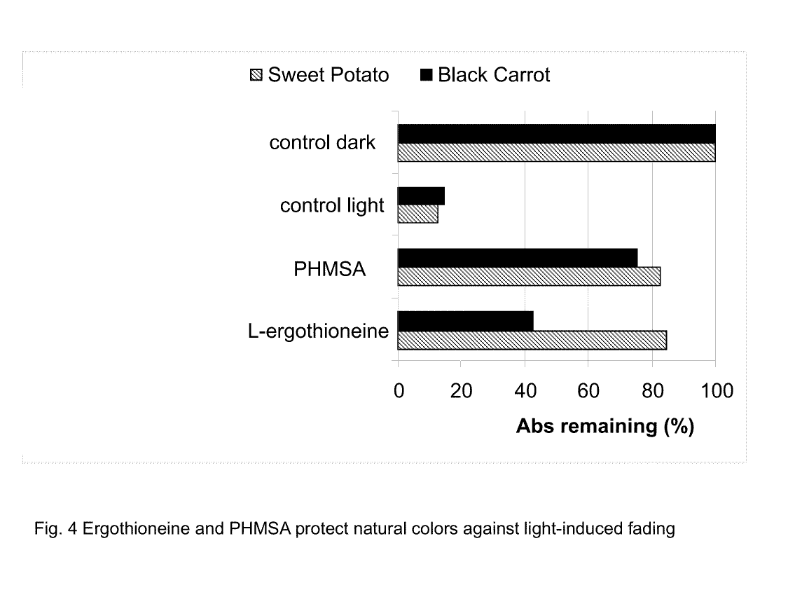

Similar results were obtained using the same colors derived from natural sources exposed to light. See FIG. 4. Light causes a reduction of over 80% in color for both sweet potato (hatched line row) and black carrot (solid row) colors. When PHMSA was added to the beverages, however, at least 75% of each color was retained (FIG. 4).

Ergothioneine has been described as an antioxidant useful for preserving foods and beverages (See U.S. Pub. No. 2010/0076093) but it has not previously been thought to protect color from natural sources against fading caused by heat or by light. Surprisingly, ergothioneine, like HMSAs, can inhibit heat- and light-induced fading of color from natural sources. See Example 1. Gardenia blue-colored beverages containing ergothioneine (FIG. 1A; Row 7) retained about 90% color when exposed to light under conditions where a control beverage retained only about 50% color. (FIG. 1A, Row 6 “Control 24 h”). Similarly, ergothioneine protected color change in colors derived from natural sources exposed to heat. Both the sweet potato- and black carrot-colored beverages exhibited improved color stability compared to ergothioneine-free controls (FIG. 3).

Juice browning results in undesirable beverage color. Advantageously, HMSAs inhibit juice browning. In an aspect of the disclosure, beverages are provided that contain at least one HMSA to inhibit juice browning in response to heat-stress.

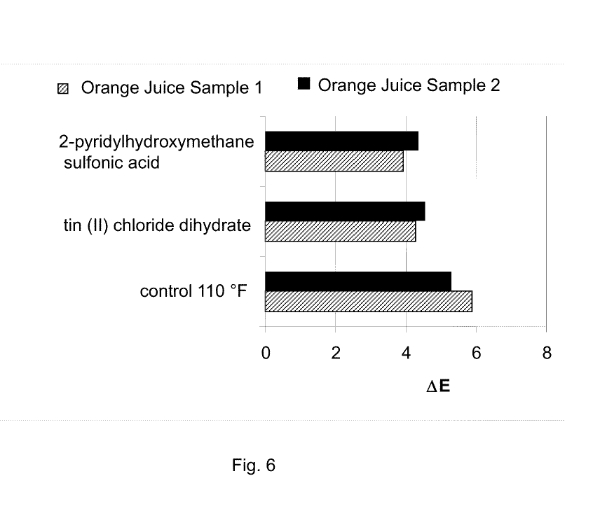

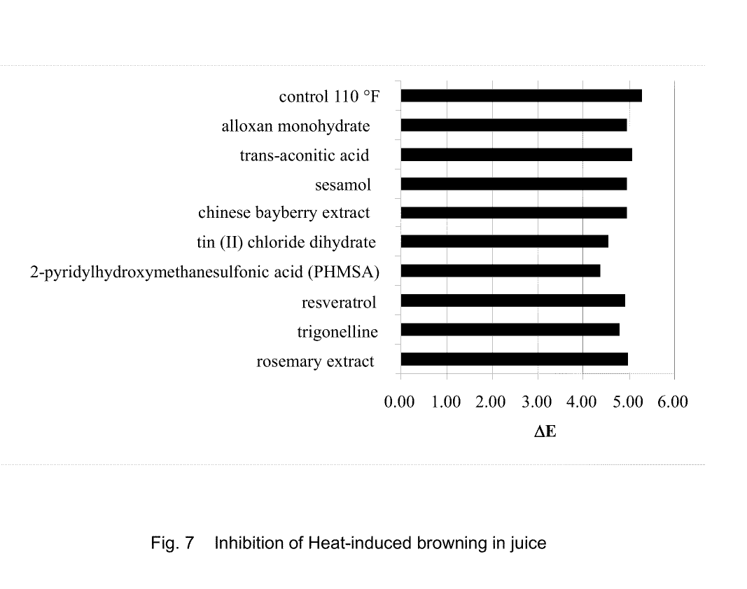

PHMSA inhibits browning in orange juice. See Example 3. FIG. 6 shows that color change of orange juice incubated at 110° F. was reduced by PHMSA. Higher ΔE here indicates increased browning. The lower ΔE in the beverage containing PHMSA indicates PHMSA inhibits juice browning in response to heat stress. FIG. 7 compares multiple compounds for their effect on browning. While many of the compounds tested had little or no effect, PHMSA exhibited substantial efficacy.

HMSAs can be used to inhibit browning in beverages at a wide pH range. Example 4 shows that PHMSA maintains reduced browning from pH 2 to pH 7. This pH range encompasses pH levels used in typical consumer beverages.

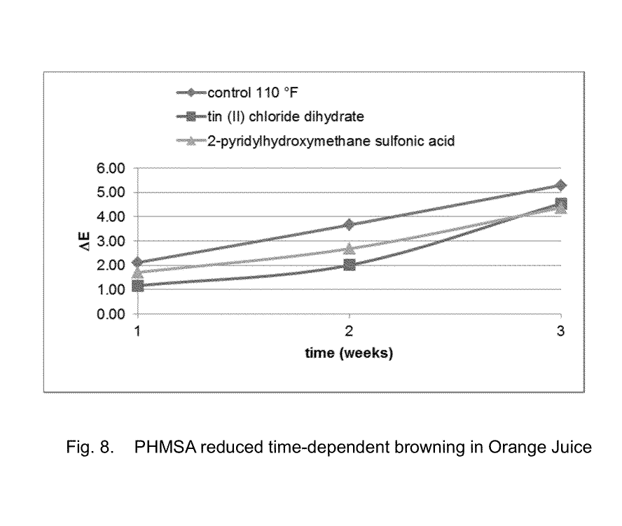

The ability of HMSAs to reduce heat-induced browning is sustained over time. See Example 5 and FIG. 8. Orange Juice incubated for three weeks at 110° F. (diamond line) showed increased browning (ΔE about 2 after 1 week rising to about 5 after 3 weeks). Tin chloride (square line), a known browning inhibitor, showed good efficacy until week two when browning more than doubled. In contrast, beverages containing PHMSA (triangle line) had less browning than control beverages and the PHMSA exhibited better efficacy than tin chloride at week three.

Color-change inhibition by HMSAs appears to relate to the structure of the stabilized alpha-hydroxymethane sulfonic acids. In particular, hydrogen bonding of nitrogen to the hydrogen creates a “six membered” ring that stabilizes the bisulfite addition product, inhibiting formation of the free bisulfite at low pH. Example 4 establishes that PHMSA is stable from pH 2 to pH 7, a pH range that encompasses the pH levels of typical consumable beverages. Because no bisulfite is released through degradation of PHMSA, the stabilized bisulfite addition product itself is important for browning inhibition

Tests with additional sulfonic acid compounds further illustrate the importance of the “six membered” ring. 4-pyridine sulfonic acid and 4-pyridyl ethane sulfonic acid, which each lack the 2-pyridyl nitrogen moiety, were tested and found not to inhibit browning (data not shown). Notably, neither compound is capable of forming the “six membered” ring.

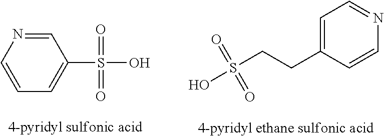 [SMILES: O=S(=O)(O)c1cccnc1 ; O=S(=O)(O)CCc1ccncc1]

These data establish that the key structural requirement for the functional effects of HMSAs on color stability is the nitrogen-hydrogen bonding available in all compounds shown in Table 1, which contributes to stabilization of the “six membered” ring.

It should be understood that beverages and other beverage products in accordance with this disclosure may have any of numerous different specific formulations or constitutions. The formulation of a beverage product in accordance with this disclosure can vary to a certain extent, depending upon such factors as the product's intended market segment, its desired nutritional characteristics, flavor profile and the like. For example, it will generally be an option to add further ingredients to the formulation of a particular beverage embodiment, including any of the beverage formulations described below. Additional (i.e., more and/or other) sweeteners may be added, flavorings, electrolytes, vitamins, fruit juices or other fruit products, tastants, masking agents and the like, flavor enhancers, and/or carbonation typically can be added to any such formulations to vary the taste, mouthfeel, nutritional characteristics, etc.

In certain embodiments of the beverage and other products disclosed here, the color derived from one or more natural sources is selected from the group consisting of purple sweet potato, black carrot, purple corn, red beet, carthamus yellow, gardenia blue, and combinations thereof. The at least one color derived from natural sources may be present in the beverage product at a concentration of between 150 and 1000 ppm, between 150 and 500 ppm, between 150 and 300 ppm, between 300 ppm and 500 ppm, or between 500 ppm and 1000 ppm. In certain embodiments, ascorbic acid is also present in the beverage product.

In general, a beverage in accordance with this disclosure typically comprises at least water, one or more colors derived from natural sources, acidulant and flavoring, and typically also sweetener. Exemplary flavorings which may be suitable for at least certain formulations in accordance with this disclosure include herbal flavoring, fruit flavoring, spice flavorings and others. Carbonation in the form of carbon dioxide may be added for effervescence. Preservatives can be added if desired, depending upon the other ingredients, production technique, desired shelf life, etc. Additional and alternative suitable ingredients will be recognized by those skilled in the art given the benefit of this disclosure.

The beverage products disclosed here include beverages, i.e., ready to drink liquid formulations, beverage concentrates and the like. Beverages include, e.g., enhanced waters, liquid, slurry or solid concentrates, fruit juice-flavored and juice-containing beverages.

At least certain exemplary embodiments of the beverage concentrates contemplated are prepared with an initial volume of water to which the additional ingredients are added. Full strength beverage compositions can be formed from the beverage concentrate by adding further volumes of water to the concentrate. Typically, for example, full strength beverages can be prepared from the concentrates by combining approximately 1 part concentrate with between approximately 3 to approximately 7 parts water. In certain exemplary embodiments the full strength beverage is prepared by combining 1 part concentrate with 5 parts water. In certain exemplary embodiments the additional water used to form the full strength beverages is carbonated water. In certain other embodiments, a full strength beverage is directly prepared without the formation of a concentrate and subsequent dilution.

Water is a basic ingredient in the beverages disclosed here, typically being the vehicle or primary liquid portion in which the remaining ingredients are dissolved, emulsified, suspended or dispersed. Purified water can be used in the manufacture of certain embodiments of the beverages disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain typical embodiments, water is present at a level of from about 80% to about 99.9% by weight of the beverage. In at least certain exemplary embodiments the water used in beverages and concentrates disclosed here is “treated water,” which refers to water that has been treated to reduce the total dissolved solids of the water prior to optional supplementation, e.g., with calcium as disclosed in U.S. Pat. No. 7,052,725. Methods of producing treated water are known to those of ordinary skill in the art and include deionization, distillation, filtration and reverse osmosis (“r-o”), among others. The terms “treated water,” “purified water,”, “demineralized water,” “distilled water,” and “r-o water” are understood to be generally synonymous in this discussion, referring to water from which substantially all mineral content has been removed, typically containing no more than about 500 ppm total dissolved solids, e.g. 250 ppm total dissolved solids.

In certain embodiments, colors derived from natural sources may be used as the only source of added colorant in beverage compositions, thereby avoiding the use of synthetic compounds to provide a desired color to the composition. In certain embodiments, the synthetic equivalents of one or more colors derived from natural sources are used as the only sources of added colorant in beverage compositions. In alternate embodiments, colors derived from natural sources, or their synthetic equivalents, may be employed in combination with synthetic colors. According to certain embodiments of the beverage products disclosed here, the colors derived from natural sources comprise one or more colors each derived from natural sources. As used herein, the term “colors derived from natural sources” includes any and all extracted products from one or more pigmented biological materials. In certain exemplary embodiments, the biological materials comprise plant materials. The coloring provided by colors derived from natural sources may be due to the presence of flavonoid compounds, such as anthocyanin compounds. Non-limiting examples of colors derived from natural sources comprising anthocyanins include purple sweet potato color, black carrot color, purple carrot color, black currant color and blueberry color. Alternatively, pigmentation can be provided by various other natural compounds, for example cyclohexene dione dimers such as carthamus yellow color, colors derived from the reaction of an iridoid and amino acids, such as found in gardenia blue color. As used herein, “synthetic equivalents” includes any and all synthetically manufactured compounds having the same structure as a color derived from a natural source.

The beverages may contain anthocyanin. As disclosed above, anthocyanins are a class of compounds that may provide pigmentation to colors derived from natural sources. For example, anthocyanins found in black currants (Ribes nigrum) that provide pigmentation include 3-diglucoside and 3-rutinoside of cyanidin and delphinidin. Similarly, blueberries (Vaccinium augustifolium or Vaccinium corymbosum) typically contain the following anthocyanins that provide pigmentation: 3-glucosides, 3-galactosides, and 3-arabinosides of cyanidin, delphinidin, peonidin, petunidin, and malvidin.

A blue color derived from natural sources is gardenia blue, which may be formed by the reaction of an iridoid and an amino acid. For example, hydrolysis of the iridoid glycoside geniposide with beta-glucosidase, as indicated below, produces the iridoid genipin. Amino acids, such as glycine, lysine or phenylalanine, will react with the colorless genipin and form blue pigments.

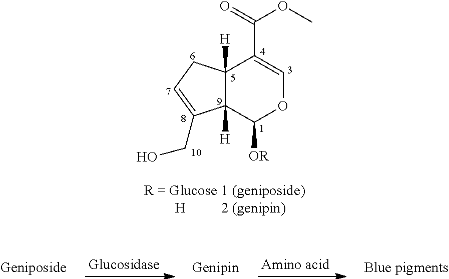

Further examples of colors derived from natural sources are carthamus yellow and carthamus red. Carthamus yellow and carthamus red may be derived from safflower (Carthamus tinctorius), and include cyclohexene dione dimers, which are classified as chalcone compounds. The chemical structure of carthamus yellow, or carthamin, is provided below.

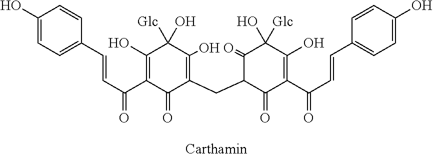

Acid used in beverages disclosed here can serve any one or more of several functions, including, for example, providing antioxidant activity, lending tartness to the taste of the beverage, enhancing palatability, increasing thirst quenching effect, modifying sweetness and acting as a mild preservative by providing microbiological stability. Ascorbic acid, commonly referred to as “vitamin C”, is often employed as an acidulant in beverages to also provide a vitamin to the consumer. Fumaric acid, maleic acid, mesaconic acid, itaconic acid and/or aconitic acid may be used alone or in combination with at least one other edible acid in a beverage composition to provide fading inhibition of colors derived from natural sources, as well as to serve any of the other purposes of acids in beverages discussed above. In certain embodiments, between about 30 ppm and 1000 ppm of an unsaturated dicarboxylic acid may be incorporated into a beverage composition to inhibit fading of colors derived from natural sources. In certain embodiments of the invention, the effective amount of one or more unsaturated dicarboxylic acids may be determined either qualitatively or quantitatively. For example, the effective amount may be an amount of unsaturated dicarboxylic acid that inhibits color fading such that any change in color is not readily noticeable to the human eye. Alternatively, the effective amount may be defined quantitatively as the amount of unsaturated dicarboxylic acid that prevents the absorbance of a beverage composition at its optimal wavelength measured using a spectrophotometer from decreasing more than a particular magnitude, such as 25% of the initial absorbance of the composition at its maximum wavelength. See also U.S. Patent Application Publication No. 20100151084.

In an embodiment of the invention, fumaric acid may be provided by an acid blend of fumaric acid, malic acid and tartaric acid, which can be commercially obtained as Fruitaric® acid, such as the Fruitaric® acid manufactured by Isegen South Africa (Pty) Ltd, Isipingo, Durban, South Africa. In certain exemplary embodiments, maleic anhydride may be added to a beverage composition with an acid, and over time the maleic anhydride will undergo hydrolysis to form maleic acid within the beverage. Any suitable edible acid may be used to hydrolyze the maleic anhydride, for example citric acid, malic acid, tartaric acid, phosphoric acid, ascorbic acid, lactic acid, formic acid, fumaric acid, gluconic acid, succinic acid and/or adipic acid.

The acid can be used in solution form, for example, and in an amount sufficient to provide the desired pH of the beverage. Typically, for example, the one or more acids of the acidulant are used in amount, collectively, of from about 0.01% to about 1.0% by weight of the beverage, e.g., from about 0.05% to about 0.5% by weight of the beverage, such as 0.1% to 0.25% by weight of the beverage, depending upon the acidulant used, desired pH, other ingredients used, etc. In certain embodiments of the invention, all of the acid included in a beverage composition may be provided by one or more alpha,beta-unsaturated dicarboxylic acids.

The pH of at least certain exemplary embodiments of the beverages disclosed here can be a value within the range of 2.5 to 4.6. The acid in certain exemplary embodiments can enhance beverage flavor. Too much acid can impair the beverage flavor and result in sourness or other off-taste, while too little acid can make the beverage taste flat and reduce microbiological safety of the product. It will be within the ability of those skilled in the art, given the benefit of this disclosure, to select a suitable acid or combination of acids and the amounts of such acids for the acidulant component of any particular embodiment of the beverage products disclosed here.

Sweeteners suitable for use in various embodiments of the beverages disclosed here include nutritive and non-nutritive, natural and artificial or synthetic sweeteners. Suitable non-nutritive sweeteners and combinations of sweeteners are selected for the desired nutritional characteristics, taste profile for the beverage, mouthfeel and other organoleptic factors. Non-nutritive sweeteners suitable for at least certain exemplary embodiments include, but are not limited to, for example, peptide based sweeteners, e.g., aspartame, neotame, and alitame, and non-peptide based sweeteners, for example, sodium saccharin, calcium saccharin, acesulfame potassium, sodium cyclamate, calcium cyclamate, neohesperidin dihydrochalcone, and sucralose. In certain embodiments the sweetener comprises acesulfame potassium. Other non-nutritive sweeteners suitable for at least certain exemplary embodiments include, for example, sorbitol, mannitol, xylitol, glycyrrhizin, D-tagatose, erythritol, meso-erythritol, maltitol, maltose, lactose, fructo-oligosaccharides, Lo Han Guo powder, xylose, arabinose, isomalt, lactitol, maltitol, trehalose, and ribose, and protein sweeteners such as thaumatin, monellin, brazzein, L-alanine and glycine, related compounds, and mixtures of any of them. Lo Han Guo, rebaudioside A, and monatin and related compounds are natural non-nutritive potent sweeteners. Suitable sweeteners also include rhamnose and sweetener fractions of stevia.

In at least certain exemplary embodiments of the beverages disclosed here, the sweetener component can include nutritive, natural crystalline or liquid sweeteners such as sucrose, liquid sucrose, fructose, liquid fructose, glucose, liquid glucose, glucose-fructose syrup from natural sources such as apple, chicory, honey, etc., e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, Lo Han Guo juice concentrate, agave and/or others. Such sweeteners are present in at least certain exemplary embodiments in an amount of from about 0.1% to about 20% by weight of the beverage, such as from about 6% to about 16% by weight, depending upon the desired level of sweetness for the beverage. To achieve desired beverage uniformity, texture and taste, in certain exemplary embodiments of the natural beverage products disclosed here, standardized liquid sugars as are commonly employed in the beverage industry can be used. Typically such standardized sweeteners are free of traces of nonsugar solids which could adversely affect the flavor, color or consistency of the beverage.

Non-nutritive, high potency sweeteners typically are employed at a level of milligrams per fluid ounce of beverage, according to their sweetening power, any applicable regulatory provisions of the country where the beverage is to be marketed, the desired level of sweetness of the beverage, etc. It will be within the ability of those skilled in the art, given the benefit of this disclosure, to select suitable additional or alternative sweeteners for use in various embodiments of the beverage products disclosed here.

Preservatives may be used in certain embodiments of the beverages disclosed here. That is, certain exemplary embodiments contain an optional dissolved preservative system. Solutions with a pH below 4 and especially those below 3 typically are “microstable,” i.e., they resist growth of microorganisms, and so are suitable for longer term storage prior to consumption without the need for further preservatives. However, an additional preservative system can be used if desired. If a preservative system is used, it can be added to the beverage product at any suitable time during production, e.g., in some cases prior to the addition of the sweetener. As used here, the terms “preservation system” or “preservatives” include all suitable preservatives approved for use in food and beverage compositions, including, without limitation, such known chemical preservatives as benzoic acid, benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), lauryl arginate ester, cinnamic acid, e.g., sodium and potassium cinnamates, polylysine, and antimicrobial essential oils, dimethyl dicarbonate, and mixtures thereof, and antioxidants such as ascorbic acid, EDTA, BHA, BHT, TBHQ, EMIQ, dehydroacetic acid, ethoxyquin, heptylparaben, and combinations thereof.

Preservatives can be used in amounts not exceeding mandated maximum levels under applicable laws and regulations. The level of preservative used typically is adjusted according to the planned final product pH, as well as an evaluation of the microbiological spoilage potential of the particular beverage formulation. The maximum level employed typically is about 0.05% by weight of the beverage. It will be within the ability of those skilled in the art, given the benefit of this disclosure, to select a suitable preservative or combination of preservatives for beverages according to this disclosure. In certain embodiments of the invention, benzoic acid or its salts (benzoates) may be employed as preservatives in the beverage products.

Other methods of beverage preservation suitable for at least certain exemplary embodiments of the beverage products disclosed here include, e.g., aseptic packaging and/or heat treatment or thermal processing steps, such as hot filling, tunnel pasteurization, and non-thermal processing. Such steps can be used to reduce yeast, mold and microbial growth in the beverage products. For example, U.S. Pat. No. 4,830,862 to Braun et al. discloses the use of pasteurization in the production of fruit juice beverages as well as the use of suitable preservatives in carbonated beverages. U.S. Pat. No. 4,925,686 to Kastin discloses a heat-pasteurized freezable fruit juice composition which contains sodium benzoate and potassium sorbate. In general, heat treatment includes hot fill methods typically using high temperatures for a short time, e.g., about 190° F. for 10 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

The beverage products disclosed here optionally contain a flavor composition, for example, natural and synthetic fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but that are commonly accepted as a berry. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime and grapefruit, and such flavors as apple, pomegranate, grape, cherry, and pineapple flavors and the like, and mixtures thereof. In certain exemplary embodiments the beverage concentrates and beverages comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots and leaves. Also included within the term “botanical flavor” are synthetically prepared flavors made to simulate botanical flavors derived from natural sources. Examples of such flavors include cola flavors, tea flavors, and the like, and mixtures thereof. The flavor component can further comprise a blend of the above-mentioned flavors. The particular amount of the flavor component useful for imparting flavor characteristics to the beverages of the present invention will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in at least certain exemplary embodiments of the beverage products disclosed here include, e.g., fruit, vegetable and berry juices. Juices can be employed in the present invention in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices can be combined, optionally along with other flavorings, to generate a beverage having the desired flavor. Examples of suitable juice sources include plum, prune, date, currant, fig, grape, red grape, sweet potato, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, lychee, lemon, orange, lime, tangerine, mandarin orange, tangelo, and pomelo and grapefruit, etc. Numerous additional and alternative juices suitable for use in at least certain exemplary embodiments will be apparent to those skilled in the art given the benefit of this disclosure. In the beverages of the present invention employing juice, juice may be used, for example, at a level of at least about 0.2% by weight of the beverage. In certain exemplary embodiments juice is employed at a level of from about 0.2% to about 40% by weight of the beverage. Typically, juice can be used, if at all, in an amount of from about 1% to about 20% by weight.

Other flavorings suitable for use in at least certain exemplary embodiments of the beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors complement that of a juice or juice combination.

The one or more flavorings can be used in the form of an emulsion. A flavoring emulsion can be prepared by mixing some or all of the flavorings together, optionally together with other ingredients of the beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Carbon dioxide can be used to provide effervescence to certain exemplary embodiments of the beverages disclosed here. Any of the techniques and carbonating equipment known in the art for carbonating beverages can be employed. Carbon dioxide can enhance the beverage taste and appearance and can aid in safeguarding the beverage purity by inhibiting and destroying objectionable bacteria. In certain embodiments, for example, the beverage has a CO₂ level up to about 7.0 volumes carbon dioxide. Typical embodiments may have, for example, from about 0.5 to 5.0 volumes of carbon dioxide. As used here and independent claims, one volume of carbon dioxide is defined as the amount of carbon dioxide absorbed by any given quantity of water at 60° F. (16° C.) temperature and atmospheric pressure. A volume of gas occupies the same space as does the water by which it is absorbed. The carbon dioxide content can be selected by those skilled in the art based on the desired level of effervescence and the impact of the carbon dioxide on the taste or mouthfeel of the beverage. The carbonation can be natural or synthetic.

The beverage concentrates and beverages disclosed here may contain additional ingredients, including, generally, any of those typically found in beverage formulations. These additional ingredients, for example, can typically be added to a stabilized beverage concentrate. Examples of such additional ingredients include, but are not limited to, caffeine, caramel and other coloring agents or dyes, antifoaming agents, gums, emulsifiers, tea solids, phytochemicals, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B, (thiamine), B₂ (riboflavin), B₃ (nicotinamide), B₄ (adenine), B₅ (pantothenic acid, calcium), B₆ (pyridoxine HCl), B₁₂ (cyanocobalamin), and K, (phylloquinone), niacin, folic acid, biotin, and combinations thereof. The optional non-mineral nutritional supplements are typically present in amounts generally accepted under good manufacturing practices. Exemplary amounts are between about 1% and about 100% RDV, where such RDV are established. In certain exemplary embodiments the non-mineral nutritional supplement ingredient(s) are present in an amount of from about 5% to about 20% RDV, where established.

### Example 1

### PHMSA Prevents Gardenia Blue Fading Induced by Heat and Light

PHMSA's ability to inhibit fading of gardenia blue, a colors derived from natural source, was tested as follows. Beverages were prepared according to the ingredients listed in Table 2 and shaken until all compounds were dissolved. Table 3 indicates compounds added to each beverage for the light stress test. Table 4 indicates compounds added to each beverage for the heat stress test. For light stress, the beverage compositions were exposed to 0.35 W/m² at 86° F. for 24 h using a Weatherometer. For heat stress, the beverage was stored at 110° F. for 1 week. Light and heat effects were evaluated by visual observation, as well as color measurement using a spectrophotometer and colorimeter. Absorbance was determined at 595 nm (maximum abs) using a spectrophotometer Shimadzu UV-1800. Color (L, a, and, b parameters) was determined using a HunterLab Color Quest XE colorimeter in total transmittance mode. pH was determined using a Metrohm 827 ph lab were measured to the selected samples.

The results of the light-stress test are shown in FIG. 1A. The degree of color of the “control 0 h” sample, Row 1, was used as the 100% value. After 24 hours exposure to light, only 44.31% color remaining (Row 6 “Control 24 h” sample). The beverage containing PHMSA showed the highest color remaining (120.36%) of the samples exposed to light for 24 hours, indicating that color is brighter with PHMSA. These data demonstrate that 333 ppm 2-pyridylhydroxymethanesulfonic acid reduces gardenia blue color fading due to light.

The data also demonstrates the ability of ascorbic acid to drive fading of color from a natural source. The beverages in Row 2 and Row 6 contained the same ingredients except that the Row 2 beverage lacked ascorbic acid. Both were exposed to light for 24 hours. The Row 6 beverage faded to a greater extent, showing that ascorbic acid (vitamin C) promotes gardenia blue fading. Thus, while the presence of vitamin C is desirable from a nutritional standpoint, its ability to promote color change creates a problem with consumer uptake. The ability of HMSAs to reduce light-induced fading driven by vitamin C is therefore particularly useful.

Visual observation of the samples confirmed the effect of PHMSA. FIG. 1B. The beverage containing PHMSA (Bottle B; 333 ppm) showed greater color intensity than control sample without light exposure (Bottle A) and much more color intensity than a sample without compound when exposed to light for 24 h (Bottle C).

PHMSA was also effective in preventing fading in response to heat-stress. FIG. 2 discloses ΔE values for beverage compositions containing gardenia blue and various compounds. Heating beverage compositions containing gardenia blue at 110° F. for 24 hours caused fading of the gardenia blue color (compare row 1 “Control 0 h” vs. row 5 “Control 24 h”). PHMSA inhibited heat-induced color change (compare row 1 “Control 0 h” vs. row 11 “PHMSA”). These data established the ability of HMSAs to inhibit fading of colors from natural sources in response to heat stress.

TABLE 2
Beverage Composition Ingredients

| Ingredient | g/L |
|---|---|
| Sucrose | 41.824 |
| Sodium benzoate | 0.2 |
| Potassium Citrate | 0.25 |
| Ascorbic acid | 0.225 |
| Citric acid anhydrous | 0.771 |
| gardenia blue color | 0.4 |
| Erythritol | 28.006 |
| water | To 1 liter |

TABLE 3
Compounds added to beverage composition to
test color stability in response to light

| Row | Compound(s) | Concentration |
|---|---|---|
| 1 | Control (0 h) | N/A |
| 2 | Control (No Vitamin C) | N/A |
| 3 | Fumaric acid and Sesamol | Fumaric Acid (667 ppm); |
| | | Sesamol (167 ppm) |
| 4 | Fumaric acid and L-lysine | Fumaric Acid (667 ppm); |
| | | L-lysine (167 ppm) |
| 5 | Fumaric acid and Coumalic acid | Fumaric Acid (667 ppm); |
| | | Coumalic Acid (167 ppm) |
| 6 | Control (24 h) | N/A |
| 7 | L-ergothioneine | 333 ppm |
| 8 | Kojic acid | 667 ppm |
| 9 | Cis-aconitic acid | 167 ppm |
| 10 | Chlorogenic acid | 167 ppm |
| 11 | ABTS (2,2′-azino-bis(3- | 50 ppm |
| | ethylbenzothiazoline-6-sulphonic | |
| | acid) | |
| 12 | 2-pyridylhydroxymethansulfonic | 333 ppm |
| | acid | |
| 13 | Coumalic acid | 333 ppm |
| 14 | GBA(Green Coffee Bean Extract) | 1667 ppm |
| 15 | GBA | 833 ppm |
| 16 | Fumaric acid | 1000 ppm |
| 17 | Fumaric acid | 500 ppm |

TABLE 4
Compounds added to beverage composition to
test color stability in response to heat

| Row | Compound(s) | Concentration |
|---|---|---|
| 1 | Control (0 h) | N/A |
| 2 | Fumaric acid and Sesamol | Fumaric Acid (667 ppm); |
| | | Sesamol (167 ppm) |
| 3 | Fumaric acid and L-lysine | Fumaric Acid (667 ppm); |
| | | L-lysine (167 ppm) |
| 4 | Fumaric acid and Coumalic acid | Fumaric Acid (667 ppm); |
| | | Coumalic Acid (167 ppm) |
| 5 | Control (24 h) | N/A |
| 6 | L-ergothioneine | 333 ppm |
| 7 | Kojic acid | 667 ppm |
| 8 | Cis-aconitic acid | 167 ppm |
| 9 | Chlorogenic acid | 167 ppm |
| 10 | ABTS | 50 ppm |
| 11 | 2-pyridylhydroxymethansulfonic | 333 ppm |
| | acid | |
| 12 | Coumalic acid | 333 ppm |
| 13 | GBA | 1667 ppm |
| 14 | GBA | 833 ppm |
| 15 | Fumaric acid | 1000 ppm |
| 16 | Fumaric acid | 500 ppm |

### Example 2

### PHMSA and Ergothioneine Reduce Heat- and Light-Induced Fading in a Variety of Colors Derived from Natural Sources

To establish that HMSAs protect against fading in multiple colors from natural sources, beverage compositions having sweet potato or black carrot colors were tested.

For light-induced fading, beverages were exposed to light for 24 h (Weatherometer, 86° F., 0.35 W/m²; FIG. 4 “control light” vs “control dark”). For heat-induced fading, beverages were heated at 110° F. for 1 week (FIG. 3 “control 110° F. vs “control 40° F.”).

FIG. 3 shows that exposure to 110° F. heat reduced absorbance to 26.72% (sweet potato) and 26.28% (black carrot). In the presence of PHMSA, absorbance was 84.13% (sweet potato) and 81.41% (black carrot), illustrating PHMSA's ability to reduce heat-induced fading. Adding ergothioneine also reduced fading. Absorbance was 68.78% (sweet potato) and 93.91% (black carrot), demonstrating that ergothioneine provides substantial protection from heat-induced fading.

FIG. 2 shows that, as with sweet potato and black carrot, ergothioneine inhibits heat-induced fading of gardenia blue. Exposing beverages containing gardenia blue to 110° F. heat for 24 h increases fading, as measured by ΔE, from about 4 to almost 8. Beverages containing ergothioneine (333 ppm) had a ΔE of less than 3 establishing that ergothioneine effectively reduces heat-induced fading of color derived from natural sources.

FIG. 4 shows that PHMSA and ergothioneine protect against light-induced fading of colors from natural sources. Light treatment reduced absorbance to 12.43% (sweet potato) and 14.42% (black carrot). In the presence of ergothioneine, however, absorbance was 84.66% (sweet potato) and 42.63% (black carrot), demonstrating substantial protection from light-induced fading. Similarly, in the presence of PHMSA, absorbance was 82.54% (sweet potato) and 75.32% (black carrot), illustrating PHMSA's ability to inhibit light-induced fading of color derived from natural sources.

FIG. 1A shows that ergothioneine inhibits light-induced fading of gardenia blue. The beverage compositions were exposed to 0.35 W/m² at 86° F. for 24 h using a Weatherometer. After 24 hours exposure to light, less than 50% color remained (compare row 1 vs. row 6). Beverages containing ergothioneine (333 ppm) retained about 90% of the color (compare row 1 vs. row 7) establishing that ergothioneine reduces light-induced fading of color derived from natural sources.

### Example 3

### PHMSA Reduces Heat-Induced Non-Enzymatic Browning in Juice

Orange Juice beverages were prepared using commercially processed orange juice concentrate (65.5-66.5 Brix; Citrosuco). The pH values of the concentrate ranged from 3.5-4.3. A typical high ratio low oil OJ concentrate was used which was diluted with treated water to 12.5 brix to make 100% single strength orange juice. Citrus juice concentrates were stored in darkness and frozen until reconstituted to single strength orange juice. The concentrate was diluted into a single strength orange juice at 12.5 brix using treated water.

The juice beverage was pasteurized at 95° C. for 6-8 seconds and filled into 15.2 Oz (450 mL) PET bottles with oxygen barrier properties and oxygen scavenging ability (Graham Packaging Company). The oxygen barrier properties reduce the incidence of bisulfite degradation to sulfate. Bisulfite and tin (II) chloride, known browning inhibitors, were used as positive controls.

Bottles containing the juice beverage were treated with different browning inhibitors as indicated in Table 3, pasteurized and stored at 110° F. in the dark for 3-4 weeks. Controls were stored at 40° F. and 110° F. without inhibitor treatment. Samples were prepared in duplicate. Before and after the study, the control samples at 40° F. and 110° F. were analyzed for: Brix, pH, dissolved oxygen, and HMF production.

In lemon juice, little change in Brix occurred after exposure to heat. After 3 weeks at 110° F. Brix, measured by refractometer, was 14 versus 13.8 for the 3-week control at 40° F. Notably, HMF increased substantially due to heat. Control at 0 weeks at 40° F. showed 226 ppb. After 3 weeks at 40° F., HMF had risen to 965.9 ppb. But after three weeks at 110° F. HMF was 34971.4 ppb.

Results in orange juice were similar. After 3 weeks at 110° F. Brix, measured by refractometer, was 12.9 versus 12.76 for the 3-week control at 40° F. Again, HMF increased substantially due to heat. Control at 0 weeks at 40° F. showed 485 ppb HMF. After 3 weeks at 40° F., HMF had risen to 550.3 ppb. After three weeks at 110° F., however, HMF was 9069.3 ppb. Notably, Vitamin C levels declined from 457.78 mg/L in the 3-week control at 40° F. to 323.62 mg/L.

Amino acid analysis (Table 5) showed that proline and lysine were the only amino acids depleted, indicating that they were being consumed in a Maillard reaction and contributing to browning.

TABLE 5

| | Time | | |
|---|---|---|---|
| | | 3 weeks | 3 weeks |
| Amino Acid | Control (Time 0) | (40° F.) | (110° F.) |
| Proline | 119 mg/100 g | 86.3 mg/100 g | 81 mg/100 g |
| | juice | juice | juice |
| Lysine | 12.6 mg/100 g | 12.4 mg/100 g | 10.4 mg/100 g |

Juice color change in response to the heat-stress was assessed using two separate approaches. First, L*, a, and b values were measured using a Hunter Lab Colorimeter values according to the CIE-Lab Color Scale. Higher L* value means a lighter color of juice. In addition to the L* measurement, a panel of four non-color blind scientist visually assessed the beverages and confirmed the L* value results.

Results from one study are shown in Table 6. Heating the beverage at 110° F. reduced lightness (L*) from 44.63, as determined for control beverage stored at 40° F., to 41.27, indicating increased browning. Beverage containing sodium bisulfite had a lightness value of 41.91. Beverage containing PHMSA had a lightness value of 42.45. Kojic acid was found to be ineffective in inhibiting browning, in contrast to previous results. See Mohamad et al. 2010. These data established that PHMSA is effective at inhibiting browning.

TABLE 6
Inhibition of Browning in Orange Juice

| Compound | L* | a* | b* |
|---|---|---|---|
| Kojic acid 167 ppm | 41.37 | 2.11 | 24.07 |
| Tin chloride 33 ppm | 42.08 | 1.88 | 25.49 |
| Sodium bisulfite 16.7 ppm | 41.91 | 1.89 | 24.31 |
| Ergothioneine 116 ppm | 40.93 | 2.22 | 23.82 |
| PHMSA 116 ppm | 42.45 | 1.8 | 25.67 |
| Control (110° F.) | 41.27 | 2.28 | 24.09 |
| Control (40° F.) | 44.63 | −0.29 | 28.17 |

### Example 4

PHMSA Inhibits Non-Enzymatic Juice Browning Over a Broad pH Range

Sodium bisulfite inhibits browning by releasing free bisulfite at low pH levels. One possible mechanism for HMSA function was release of bisulfite from the HMSAs. To investigate the mechanism, PHMSA pH stability was tested by measuring picolinic aldehyde (PA) formation. PA is a precursor aldehyde of PHMSA and is formed when PHMSA decomposes. Because chromatographic analysis by HPLC is extremely complex in orange juice, PHMSA decomposition was assessed in heated beverage models.

Beverage model compositions were prepared by dissolving PHMSA (80 mg) in 50 mL of four different buffers. The compositions were prepared using suitable acids, such as citric acid and phosphoric acid to provide solutions at pH 2, 4, 7, and 9, which were heated at 110° F. for 3 weeks. PA formation was evaluated by HPLC on RPC18 with water and 0.1% acetic acid as eluent. HPLC conditions were optimized for detection of PHMSA and picolinic aldehyde formation by UV monitoring at 254 nm. A picolinic aldehyde standard was used as a reference to measure conversion of PHMSA to the aldehyde.

The retention time of PHMSA in the HPLC was 4.13 minutes (80 mg/50 mL). The retention time of picolinic aldehyde was 10.13 minutes (40 mg/50 mL). The PA (picolinic aldehyde) concentration was used to approximate 100% of aldehyde content per mole degradation of the PHMSA.

We detected no picolinic aldehyde in the beverage models at pH 2, 4, or 7, indicating that PHMSA is stable at these pH levels (data not shown). At pH 9, however, a small amount of picolinic aldehyde was detected, indicating that PHMSA remains substantially stable even up to about pH 9. These data suggest that PHMSA remains in the addition product state up to at pH 7. PHMSA is therefore useful for browning inhibition and preventing fading of colors from natural sources or their synthetic equivalents from pH 2 to pH 7.

Further, the data implies that PHMSA operates in a mechanism unlike that of bisulfite. At acid pH, sodium bisulfite releases free bisulfite, which inhibits browning. If fully dissociated, PHMSA (MW 189.2 grams/mole) provides 56.6% aldehyde and 43.3% of bisulfite. Thus, assuming complete dissociation, adding 75 mg of PHMSA per bottle would supply about 32.5 mg of bisulfite. This amount of bisulfite would offer superb browning inhibition. However, because PHMSA did not release bisulfite at acid or neutral pH, PHMSA must inhibit color fading and browning by a different mechanism. For example, PHMSA may be absorbing light or acting as a radical scavenger, a metal chelator, or an oxidation sponge antioxidant.

### Example 5

### PHMSA Protects Against Heat-Induce Browning Over Sustained Periods

Experiments were performed to assess how long PHMSA protects against color change.

PHMSA or tin chloride was each added to a juice beverage. The beverages were then incubated at 110° F. for extended periods of time. ΔE, indicating increased browning, was measured at 1, 2, and 3 weeks. As shown in Table 7 and represented graphically in FIG. 8, PHMSA had a sustained inhibitory effect on browning. Notably, while tin chloride was effective in the short term, it appeared to become less effective during extended heating, resulting in an increase in ΔE from 2.00 to 4.54 between the second and third week. In contrast, while PHMSA showed less effective browning inhibition after one week compared to tin chloride, PHMSA exhibited greater efficacy at week 3.

TABLE 7
Effect of Tin Chloride and PHMSA on Browning
at 110° F. for extended periods

ΔE

| Compound | 1 Week | 2 Weeks | 3 Weeks |
|---|---|---|---|
| Control | 2.11 | 3.66 | 5.29 |
| Tin (II) chloride dihydrate | 1.16 | 2.00 | 4.54 |
| PHMSA | 1.71 | 2.68 | 4.37 |

### Example 6

### Ergothioneine Reduces Heat-Stress-Induced Non-Enzymatic Browning in Lemon Juice

Ergothioneine reduces lemon juice browning to a similar extent as sodium bisulfite.

Lemon juice compositions were prepared containing the compounds listed in table 8 then exposed to 110° F. heat. Control juice compositions with no compounds added were incubated at 110° F. and at 40° F. The heat stress caused a decrease in lemon juice color lightness (L*) from 95.96 to 94.28. Ergothioneine inhibited the heat-induced decrease. Color lightness was 95.69 and 95.36 when 25 ppm and 50 ppm Ergothioneine were included in the juice, respectively. This degree of protection is similar to sodium bisulfite. Adding sodium bisulfite at 16.7 ppm or at 8.5 ppm, provided lightness values of 95.65 and 95.37, respectively. Ergothioneine thus offers protection against browning to the same extent as sodium bisulfite but does not suffer from the possible allergen issues associated with sodium bisulfite use.

TABLE 8
Ergothioneine protects against heat-
induced browning in lemon juice

| Compound | Amount/beverage | L* | a* | b* |
|---|---|---|---|---|
| Ergothioneine (high) | 50 ppm | 95.36 | 0.56 | 5.9 |
| Ergothioneine (low) | 25 ppm | 95.69 | 0.5 | 6.08 |
| Sodium bisulfite (high) | 16.7 ppm | 95.65 | 0.54 | 6.77 |
| Sodium bisulfite (low) | 8.5 ppm. | 95.37 | 0.55 | 6.75 |
| Control (110° F.) | | 94.28 | 0.62 | 8.37 |
| Control (40° F.) | | 95.96 | 0.76 | 4.64 |

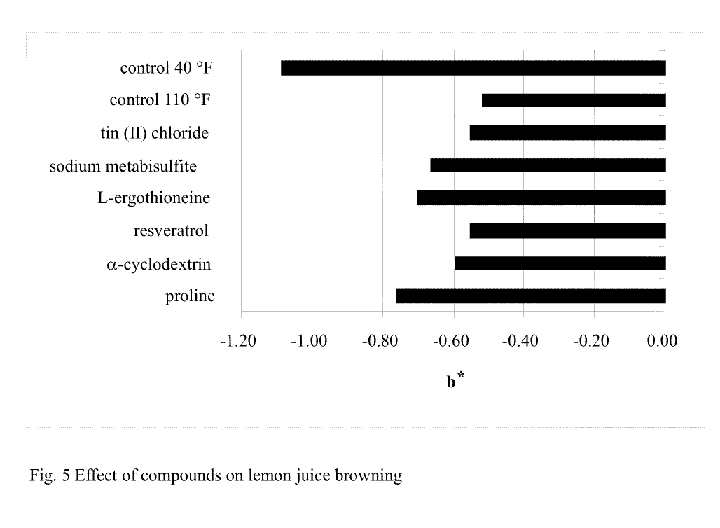

Similar data is presented in FIG. 5. FIG. 5 shows the b* values for lemon juice beverages. Lower b* value indicates less browning. Heat treatment of the lemon juice increased browning (Compare “control 110° F.” vs. “control 40° F.”). Ergothioneine was effective in reducing heat-induced browning.

Orange juice beverages containing compounds as listed in Table 9 were heated at 110° F. for 3 weeks. An unheated control was maintained at 40° F. The heat stress at 110° F. caused a decrease in color lightness from 40.16 to 36.63. Positive controls, tin chloride and sodium bisulfite, both maintained juice lightness at 39.32. PHMSA and ergothioneine maintained juice lightness at 38.68 and 39.01, respectively. In contrast to the results obtained with ergothioneine and PHMSA, dehydroascorbic, and hypotaurine were not effective in preventing heat-induced browning.

TABLE 9
Juice color for beverages containing
various compounds heated at 110° F.

| Compound | L* | a* | b* |
|---|---|---|---|
| Kojic acid | 37.51 | 0.71 | 18.65 |
| Tin chloride | 39.32 | 0.43 | 19.91 |
| Sodium bisulfite | 39.32 | 0.43 | 19.91 |
| Ergothioneine | 39.01 | 0.67 | 19.6 |
| PHMSA | 38.68 | 0.37 | 20.39 |
| Dehydroascorbic acid | 36.31 | 1.89 | 17.94 |
| Hypotaurine | 36.92 | 0.64 | 18.23 |
| Control (110° F.) | 36.63 | 0.34 | 19.94 |
| Control (40° F.) | 40.16 | −1.47 | 20.9 |

Calculations from two separate heat stressed-orange juice trials, shown in table 10, established the reproducibility of browning inhibition by PHMSA and by ergothioneine.

TABLE 10
ΔE values from two Orange juice trials.

| | Trial 1 | Trial 2 |
|---|---|---|
| Beverage | ΔE @ 3 weeks | ΔE @ 3 weeks |
| Control (110° F.) | 5.02 | 5.3 |
| Tin (II) chloride | 4.16 | 4.58 |
| Sodium bisulfite | 4.96 | 5.3 |
| PHMSA | 4.02 | 4.4 |
| Ergothioneine | 4.35 | 4.5 |

FIG. 6 illustrates data for two additional trials. PHMSA reduces color change in orange juice, as measured by ΔE, compared to the control heated at 110° F.

While particular embodiments have been described and illustrated, it should be understood that the invention is not limited thereto since modifications may be made by persons skilled in the art. The present application contemplates any and all modifications that fall within the spirit and scope of the underlying invention disclosed and claimed herein. The contents of each of the cited journal articles, patents, and published patent applications are hereby incorporated by reference as if set forth fully herein.

### REFERENCES

Ashurst, P. R., ed. Chemistry and technology of Soft Drinks and Fruit Juices. blackwell Publishing, Oxford, UK 2005.
Berk, Z., Mannheim, C. 1986, The Effect of Storage Temperature on Quality Citrus Products Aseptically Packed into Steel Drums. Journal of Food Processing and Preservation. 10 (4): 281-293.
Berlinet, C., Brat, P., Brillouet, J. M., Ducruet, V., 2006, Ascorbic Acid, Aroma Compounds and Browning of Orange Juices Related to PET Packaging Materials and pH. Journal of the Science of Food and Agriculture, 86:2206-2212.
Buedo, A. E., Elustondo, M. P., Urbicain, M. J., 2001, Non-enzymatic Browning of Peach Juice Concentrate during Storage. Innovative Food Science and Emerging Technologies, 1 (4): 255-260.
Chung, Y. Chu, O., Sanders, T., 2005, Reduction of Non-Enzymatic Browning in Citrus Peel Juice. 170233/11 US Patent 06.
Clegg, K. M., 1964, Non-Enzymatic Browning of Lemon Juice, Journal of Science Food and Agriculture, 15: 878-885.
Culver, C. A., Wrolstad, R. E., eds., Color Quality of Fresh and Processed Foods. American Chemical Society (ACS Symposium Series), Washington, D.C. 2008.
Damodaran, S. Parkin, K. L., Fennema, O. R. et. al. Fennema's Food Chemistry Fourth Edition. CRC Press, Boca Raton, Fl. 2008.
Garza, S., Ibarz, A., Pagan, J., Giner, J., 1999, Nonenzymatic Browning in Peach Puree during Heating. Food Research International, 32: 335-343.
Hui, Y. H. et. Al., eds. Handbook of Fruits and Fruit Processing. blackwell Publishing, 2006.
Ibarz, A., Garza, S. Pagan, J., 2008, Nonenzymatic Browning of Selected Fruit Juices by D-galacturonic Acid. Journal of Food Science, 43: 908-914.
Kefford, J. F., McKenzie, H. A., Thompson, P. C. O., 1958, Effect of Oxygen on Quality and Ascorbic Acid Retention in Canned and Frozen Orange Juices. Journal of Science Food and Agriculture, 10 (1): 51-63
Koca, N., Selen Burdurlu, H. Karadeniz, F., 2003, Kinetics of Nonenzymatic Browning Reaction in Citrus Juice Concentrates during Storage. Turkish Journal of Agriculture and Forestry, 27: 353-360.
Kus S; Gogus F; Eren S, 2005. Hydroxymethyl Furfural Content of Concentrated Food Products. International Journal of Food Properties, 8 (2): 367-375.
Lee, H. S., Nagy, S., 1996, Chemical Degradation Indicators to Monitor the Quality of Processed and Stored Citrus Products. In “Chemical Markers for Processed and Stored Foods” 86-106. Lee T., Kim H., eds., ACS Symposium Series 631.
Lee, H. S., Nagy, S., 1988, Relationship of Sugar Degradation to Detrimental Changes in Citrus Juice Quality, Food Technology, 42 (11): 91-97.
Lewis, M. J., Heppell, N. J., Continuous Thermal Processing of Foods: Pasteurization and UHT Sterilization. Aspen Publishers, Gaitjersburg, Md., 2000.
Lozano, Jorge E. Fruit Manufacturing. Springer, N.Y., N.Y., 2006.
Mannheim, C. H., Milt, J., Letzter, A., 1987, Interaction between Polyethylene Laminated Cartons and Aseptically Packed Citrus Juices, Journal of Food Science, 52 (3): 737-740.
Mohamad, R., Mohamed, M. S., Suhaili, N., Salleh, M. M., Ariff, A. B., 2010, Kojic Acid: Applications and Development of Fermentation Process for Production, Biotechnology and Molecular Biology Reviews, 5 (2): 24-37.
Naim, M., Wainish, S., Uri, Z., Peleg, H., Rouseff, R. L., Nagy, S., 1993. Inhibition by Thiol Compounds of Off-Flavor Formation in Stored Orange Juice. 1. Effect of L-cysteine and N-acetyl-L-cysteine on 2,5-dimethyl-4-hydroxy-3(2H)-furanone Formation, Journal of Agricultural and Food Chemistry, 41(9): 1355-1358.
Nuray, K., Burdurlu, H. S., Karadeniz, F., 2003, Kinetics of Nonenzymatic Browning Reaction in Citrus Juice. Turkish Journal of Agriculture and Forestry, 27: 353-360.
Paine, F. A., Paine, H. Y., Handbook of Food Packaging. Springer, N.Y., N.Y., 1993.
Roig, M. G., Bello, J. F., Rivera, Z. S., Kennedy, Z. S., 1999, Studies on the occurrence of non-enzymatic browning during storage of citrus juice. Food Research International, 32: 609-619.
Ros-Chumillas, M., Beliassario, Y., Iguaz, A., Lopez, A., 2007, Quality and Shelf Life of Orange Juice Aseptically Packaged in PET Bottles. Journal of Food Engineering, 79 (1): 234-242.
Sapers, G. M., 1993, Browning of Foods: Control by Sulfites, Antioxidants and Other Means. Food Technology, October, 75-84.
Sawarnura M; Nakagawa T; Katsuno S; Hamaguchi H; Ukeda H., 2000, The Effects of Antioxidants on Browning and on Degradation Products Caused by Dehydroascorbic acid. Journal of Food Science, (January-February), 65 (1): 20-23.
Shinoda, Y., Komura, H. Homma, S. Murata, M. 2005, Browning of Model Orange Juice Solutions: Factors Affecting the Formation of Decomposition Products. Japan: Bioscience, Biotechnology, and Biochemistry, 69 (11): 2129-2137.
Shinoda, Y., Murata, M., Homma, S., Komura, H., 2004, Browning and Decomposed Products of Model Orange Juice. Japan: Bioscience, Biotechnology, and Biochemistry, 68 (3): 529-536.
Taylor, S. L., Higley, N. A., and Bush, R. K. 1986. Sulfites in Foods: Uses, Analytical Methods, Residues, Fate, Exposure Assessment, Metabolism, Toxicity, and Hypersensitivity, Advanced Food Research, 30:1-76.
Uscherek, M., 2000, The application of multidimensional analysis to assessment of the quality of food products and their packaging. Packaging Technology and Science, 13: 73-82.
Ziderman, I., Gregorski, K. S., Lopez, S. V., Friedman, M., 1989, Thermal Interaction of Ascorbic Acid and Sodium Ascorbate with Proteins in Relation to Nonenzymatic Browning and Maillaid Reactions of Foods. Journal of Agricultural and Food Chemistry, 37:1480-1485.

What is claimed is:

1. A beverage product comprising:
water;
a color derived from a natural source or its synthetic equivalent; and
a compound selected from a hydroxymethane sulfonic acid (HMSA) and ergothioneine to inhibit fading of the color derived from a natural source or its synthetic equivalent.

2. The beverage product of claim 1 wherein the compound is the HMSA and the HMSA is of Formula I: 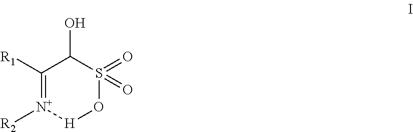
wherein R₁ and R₂, together with the nitrogen, form a pyridine, a quinoline, a pyrimidine, a tetrahydropyrimidine, an imidazole, a quinoxaline, a riboflavin, or a pteridine.

3. The beverage product of claim 2 wherein the HMSA is 2-pyridyl hydroxymethane sulfonic acid.

4. The beverage product of claim 1 wherein the natural source is selected from the group consisting of: purple sweet potato, black carrot, purple carrot, black currant, blueberry, carthamus yellow, gardenia blue, and combinations thereof.

5. The beverage product of claim 1, wherein the compound is present at a concentration of between about 30 ppm and about 1000 ppm.

6. The beverage product of claim 1 wherein the compound is ergothioneine.

7. A beverage product comprising:
a juice, and an inhibitor in an effective amount to inhibit non-enzymatic browning, the inhibitor comprising a hydroxymethane sulfonic acid (HMSA).

8. The beverage product of claim 7 wherein the HMSA is of Formula I: 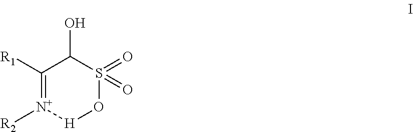
wherein R₁ and R₂, together with the nitrogen, form a pyridine, a quinoline, a pyrimidine, a tetrahydropyrimidine, an imidazole, a quinoxaline, a riboflavin, or a pteridine.

9. The beverage product of claim 8 wherein the HMSA is a pyridyl hydroxymethane sulfonic acid.

10. The beverage product of claim 7 wherein the non-enzymatic browning is light-induced.

11. The beverage product of claim 7 wherein the non-enzymatic browning is heat-induced.

12. The beverage product of claim 7, wherein the compound is present at a concentration of between about 30 ppm and about 1000 ppm.

13. The beverage product of claim 7, wherein the juice is a fruit juice.

14. A method of inhibiting color change in a beverage product comprising adding an effective amount of a hydroxymethane sulfonic acid (HMSA) to a beverage.

15. The method of claim 14 wherein the color change is heat-induced fading.

16. The method of claim 14 wherein the color change is light-induced fading.

17. The method of claim 14 wherein the color change is non-enzymatic browning.

18. The method of claim 14 wherein the HMSA is of Formula I: 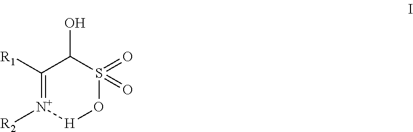
wherein R₁ and R₂, together with the nitrogen, form a pyridine, a quinoline, a pyrimidine, a tetrahydropyrimidine, an imidazole, a quinoxaline, a riboflavin, or a pteridine.

19. The method of claim 18 wherein the hydroxymethane sulfonic acid is a pyridyl hydroxymethane sulfonic acid.
